(19) United States
(12) Patent Application Publication
(10) Pub. No.: US 2017/0335435 A1
(43) Pub. Date: Nov. 23, 2017

(54) A TURBINE ENGINE PART INCLUDING A TITANIUM-BASED ALLOY

(71) Applicants: SAFRAN AIRCRAFT ENGINES, Paris (FR); TIMET SAVOIE, Ugine (FR); CENTRE NATIONAL DE LA RECHERCHE SCIENTIFIQUE (CNRS), Paris (FR); ECOLE NATIONALE SUPERIEURE DE CHIMIE PARIS, Paris Cedex 05 (FR)

(72) Inventors: Béatrice PELTIER, Moissy-Cramayel Cedex (FR); Cédrik BROZEK, Paris (FR); Yvon MILLET, Villeurbanne (FR); Frédéric PRIMA, Paris (FR)

(21) Appl. No.: 15/522,998

(22) PCT Filed: Oct. 28, 2015
(86) PCT No.: PCT/FR2015/052899

§ 371 Date: Apr. 28, 2017

(30) Foreign Application Priority Data
Oct. 31, 2014 (FR) 1460497

(51) Int. Cl. C22C 14/00; C22F 1/00; F01D 25/24; B22D 7/00; C22F 1/18; C22C 1/02

(52) U.S. Cl. CPC C22C 14/00; C22F 1/183; C22C 1/02; F01D 25/24; B22D 7/005; C22F 1/002; F05D 2220/30; F05D 2300/174

(57) ABSTRACT

The present invention relates to a turbine engine part including a titanium-based alloy presenting a high level of work hardening, a high breaking load, and good ductility.

### BACKGROUND OF THE INVENTION

The invention relates to novel titanium alloys presenting improved mechanical properties.

Commercial titanium alloys can present little or no work hardening at ambient temperature, and also ductility that is relatively low (10% to 15% on average). That type of behavior is associated with known technique for hardening titanium alloys that make it possible to obtain properties that are good in terms of mechanical strength but potentially at the cost of limiting the capacity of the material for deformation, and consequently leading to low ductilities.

Known titanium alloys therefore do not constitute good materials for making parts that might potentially be subjected to high levels of deformation while conserving good static properties, such as for example casings that need to retain items in the event of ingestion or of parts rupturing. Consequently, certain known titanium alloys are dismissed from applications of this type in favor of steels, which are significantly heavier.

There therefore exists a need to have novel titanium alloys presenting high levels both of work hardening and of ductility.

### OBJECT AND SUMMARY OF THE INVENTION

To this end, in a first aspect, the invention provides a titanium-based alloy in which one or more alloying elements are present, the alloy satisfying the following conditions:

$$4.10 \leq \frac{e}{a} \leq 4.16 ;$$

$$10 \leq {Mo}_{eq} \leq 14.5 ;$$

$$2.77 \leq Bo \leq 2.80 ; and$$

$$2.34 eV \leq Md \leq 2.38 eV ;$$

where Mo_{eq} designates the content by weight of beta-stabilizing elements in the alloy expressed as molybdenum equivalent,
where

$$\frac{e}{a} = \sum \frac{{e}_{i}}{{a}_{i}} {x}_{i} , where \frac{{e}_{i}}{{a}_{i}}$$

is the number of valence electrons of the element i and xᵢ is the molar fraction of the element i in the alloy; the sum being performed over all of the elements present in the alloy, where Bo designates the mean bond order of covalent bonds between titanium and the alloying elements; and where Md designates the mean energy level in eV of the d orbitals corresponding to the covalent bonds between titanium and the alloying elements.

The term “titanium-based alloy” should be understood as meaning that titanium constitutes the base metal of the alloy, i.e. that the alloy includes titanium at a content by weight that is greater than or equal to 50%, e.g. greater than or equal to 60%, e.g. greater than or equal to 70%, e.g. greater than or equal to 80%.

The quantity Mo_{eq} is given by the following equation:

Mo_{eq}=ΣMoᵢzᵢ

where zᵢ is the fraction by weight in the alloy of the alloying element i, and Moᵢ corresponds to the ratio of the beta-stabilizing coefficient of the alloying element i divided by the beta-stabilizing coefficient of Mo, with the sum being taken over all of the alloying elements present in the alloy. Thus, the sum relates both to the beta-stabilizing alloying elements and also to the alpha-stabilizing alloying elements that might be present in the alloy, which elements present a coefficient Moᵢ that is negative.

For each of the alloying elements, the quantities Moᵢ and/or eᵢ/aᵢ are tabulated. Table 1 below gives the values of these quantities for a few examples of alloying elements.

TABLE 1

| | Al | Sn | Cr | V | Ti |
|---|---|---|---|---|---|
| Moᵢ | −1 | −0.33 | +1.60 | +0.67 | |
| eᵢ/aᵢ | 3 | 4 | 6 | 5 | 4 |

Bo quantifies the mean cohesive force of the covalent bonds between titanium and the alloying elements. More precisely, the quantity Bo is calculated as follows:

Bo=ΣBoᵢxᵢ

where xᵢ designates the molar fraction of the element i in the alloy, with the sum being taken over all of the elements present in the alloy. The values Boᵢ are tabulated and are given for various alloying elements in Table 2 below. Md designates the mean energy level of the d orbitals corresponding to the covalent bonds that result from the interaction between titanium and the alloying elements. More precisely, the quantity Md is calculated as follows:

Md=ΣMdᵢxᵢ

where xᵢ designates the molar fraction of the element i in the alloy, with the sum being taken over all of the elements present in the alloy. The values Mdᵢ are tabulated and are given for various alloying elements in Table 2 below:

TABLE 2

| | Al | Sn | Cr | V | Ti |
|---|---|---|---|---|---|
| Boᵢ | 2.43 | 2.28 | 2.78 | 2.81 | 2.79 |
| Mdᵢ | 2.20 | 2.10 | 1.48 | 1.87 | 2.45 |

The parameters

$$\frac{e}{a} ,$$

Mo_{eq}, Bo, and Md are known in the literature. In particular, various publications describe how to calculate the parameters Bo and Md. On this topic, mention may be made by way of example of: the publication by Abdel-Hady et al. “General approach to phase stability and elastic properties of β-type Ti-alloys using electronic parameters”, Scripta Materialia 55 (2006) pp. 477-480; the publication by Marteleur et al. “On the design of new β-metastable titanium alloys with improved work hardening rate thanks to simultaneous TRIP and TWIP effects”, Scripta Materialia 66 (2012), pp. 749-752; and the publication by Sun et al., “Investigation of early stage deformation mechanisms in a metastable β-titanium alloy showing combined twinning-induced plasticity and transformation-induced plasticity effects”, Acta Materialia 61 (2013), pp. 6406-6417.

Unless specified to the contrary, in the chemical alloy formulae used below, the number situated in front of a chemical element is the content by weight in % of that element in the alloy. For example, the alloy Ti-8.5Cr-1.5Al is a titanium-based alloy including Cr at a content by weight equal to 8.5% and Al at a content by weight equal to 1.5%.

Alloys of the invention advantageously present a high degree of work hardening, a high breaking load, and good ductility. The above-explained choices for parameter ranges enable the alloy to be hardened and activate modes of deformation that make it possible to obtain a high degree of ductility by involving twinning mechanisms and mechanisms for transforming β phase into a phase.

In the alloys of the invention, the combination of a twinning-induced plasticity (TWIP) effect with a transformation-induced plasticity (TRIP) effect is advantageously activated. The invention results in selecting particular alloys that are defined on the basis of the above-described parameters that make it possible simultaneously to activate a martensitic transformation mechanism with twinning and slip mechanisms.

By activating these phenomena, alloys of the invention may in particular present ductilities of the order of 40% while conserving high elastic limits (greater than 500 megapascals (MPa)). Such performance constitutes a technical breakthrough compared with the performance of known titanium alloys.

In an embodiment, the alloy may include at least one alloying element selected from the following list: Cr, Al, Sn, and V.

In an embodiment, the alloy may include Cr and Al as alloying elements.

In an embodiment, the alloy may include Cr and Sn as alloying elements.

In an embodiment, the alloy may include V and Al as alloying elements.

The alloy may be a binary alloy or a ternary alloy. The alloy preferably consists in a Ti—Cr—Al ternary alloy or in a Ti—Cr—Sn ternary alloy. The alloy may also constitute a Ti—V—Al ternary alloy. The alloy may also be a quaternary alloy, e.g. a Ti-10V-4Cr-1Al alloy.

In an embodiment, the allay may include Cr and Al as alloying elements and the content by weight of Cr in the alloy may lie in the range 6% to 9%, e.g. in the range 7% to 9%, and the content by weight of Al in the alloy may lie in the range 1% to 3%.

In particular, the alloy may have the following chemical formula: Ti-xCr-yAl, where x lies in the range 6 to 9, or indeed in the range 7 to 9, and y lies in the range 1 to 3.

In an embodiment, the alloy may include Cr and Sn as alloying elements, and the content by weight of Cr in the alloy may lie in the range 6% to 9%, e.g. in the range 7% to 9%, and the content by weight of Sn in the alloy may lie in the range 1% to 5%.

In particular, the alloy may have the following chemical formula: Ti-x′Cr-zSn, where x′ lies in the range 6 to 9, or indeed in the range 7 to 9, and z lies in the range 1 to 5.

In particular, the alloy of the invention may have any one of the following chemical formulae:
Ti-8.5Cr-1.5Al;
Ti-8.5Cr-1.5Sn;
Ti-7.5Cr-1Al;
Ti-7.5Cr-2Al;
Ti-9.5Cr-2Al;
Ti-7Cr-2Sn; and
Ti-13V-2.5Al.

In an embodiment, the content by weight of Cr in the alloy may lie in the range 7% to 9%.

The present invention also provides a turbine engine part including a titanium-based alloy, the alloy being:
a Ti—Cr—Al ternary alloy in which the content by weight of Cr in the alloy lies in the range 6% to 9% and the content by weight of Al in the alloy lies in the range 1% to 3%; or
a Ti—Cr—Sn ternary alloy in which the content by weight of Cr in the alloy lies in the range 6% to 9% and the content by weight of Sn in the alloy lies in the range 1% to 5%.

Preferably, the part is a turbine engine casing, e.g. a turbine engine retention casing.

The part may be made of an alloy as defined above.

The present invention also provides a turbine engine including a part as defined above.

### BRIEF DESCRIPTION OF THE DRAWINGS

Other characteristics and advantages of the invention appear from the following description of particular embodiments of the invention given as non-limiting examples and with reference to the accompanying drawings, in which:

FIGS. 1 and 2 are electronic diagrams showing the positioning of example alloys of the invention;

FIG. 3 shows the “TRIP” effect in which there is a phenomenon of a β phase transforming into an α″ phase in a Ti-8.5Cr-1.5Al alloy of the invention;

FIGS. 4A and 4B are photographs showing the twinning phenomenon in a Ti-8.5Cr-1.5Sn alloy of the invention; and

FIGS. 5 and 6 show the results of traction tests on alloys of the invention.

### DETAILED DESCRIPTION OF EMBODIMENTS

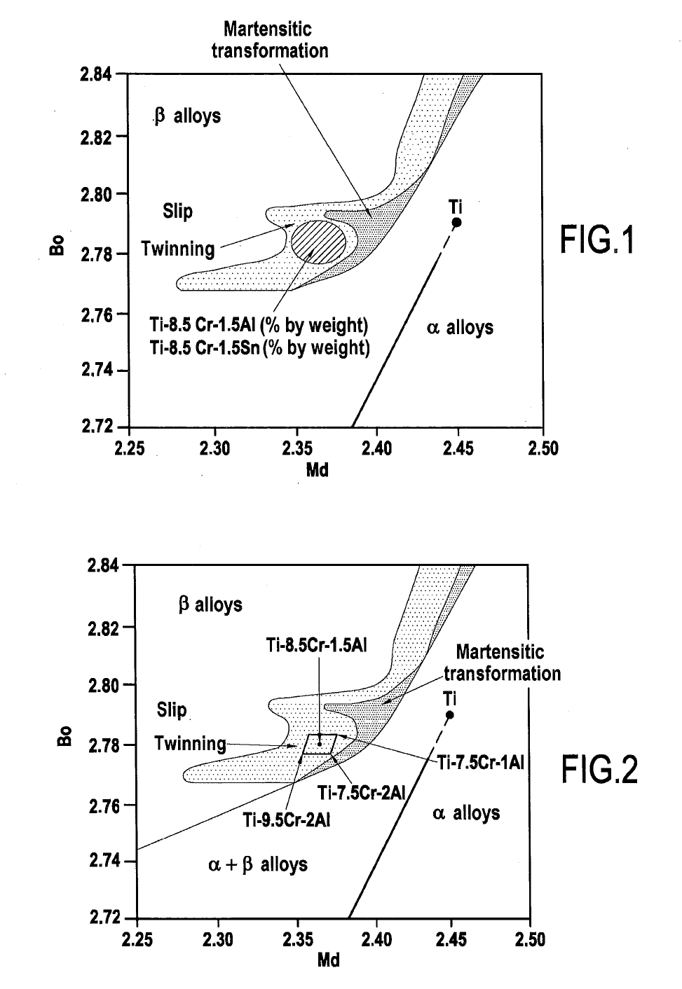

FIGS. 1 and 2 are electronic diagrams with titanium alloys positioned thereon. These electronic diagrams show the deformation mechanisms that take place when the alloy is subjected to stress.

Bo is plotted up the ordinate axis of the electronic diagrams of FIGS. 1 and 2. As mentioned above, Bo quantifies the mean cohesive force of covalent bonds between titanium and the alloying elements.

Md is plotted along the abscissa axis of the electronic diagrams of FIGS. 1 and 2. As mentioned above, Md specifies the mean energy level of d orbitals corresponding to the covalent bonds that result from the interaction between titanium and the alloying elements.

The electronic diagrams provided in FIGS. 1 and 2 show various regions corresponding to different deformation mechanisms taking place: slip, twinning, and stress induced martensitic (SIM) transformation.

As shown, various example alloys of the invention are positioned on the electronic diagrams of FIGS. 1 and 2 in the zone corresponding to activating twinning phenomena. For example it is possible to have: 2.77≦Bo≦2.79 and 2.34 eV≦Md≦2.38 eV for alloys of the invention.

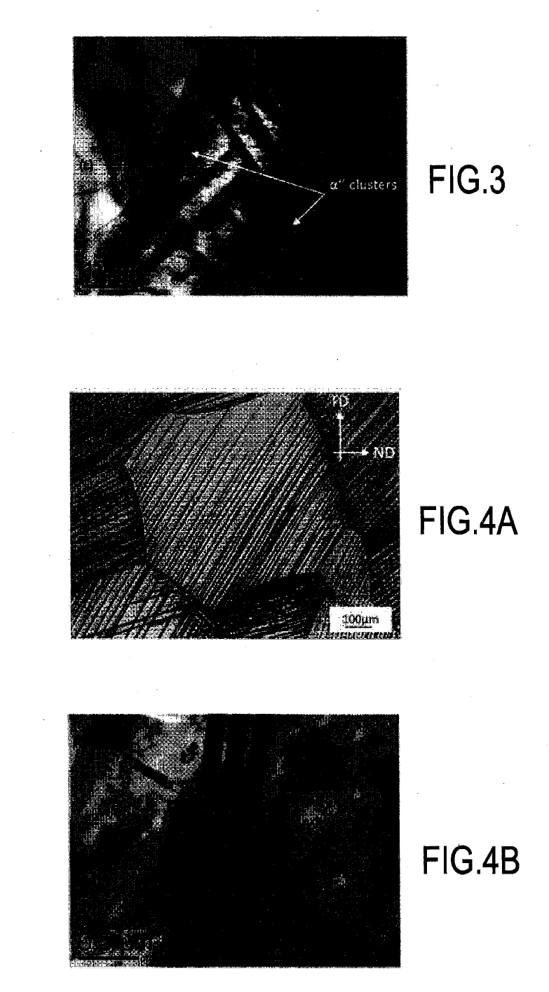

FIG. 3 is a photograph showing an α″ phase obtained in an alloy of the invention from a β phase (activation of the mechanism for transforming a β phase into an α″ phase when applying a stress). Activating such a phase transformation contributes advantageously to obtaining high ductility. FIGS. 4A and 4B show the activation of a twinning phenomenon obtained in an alloy of the invention, which also contributes to obtaining high ductility.

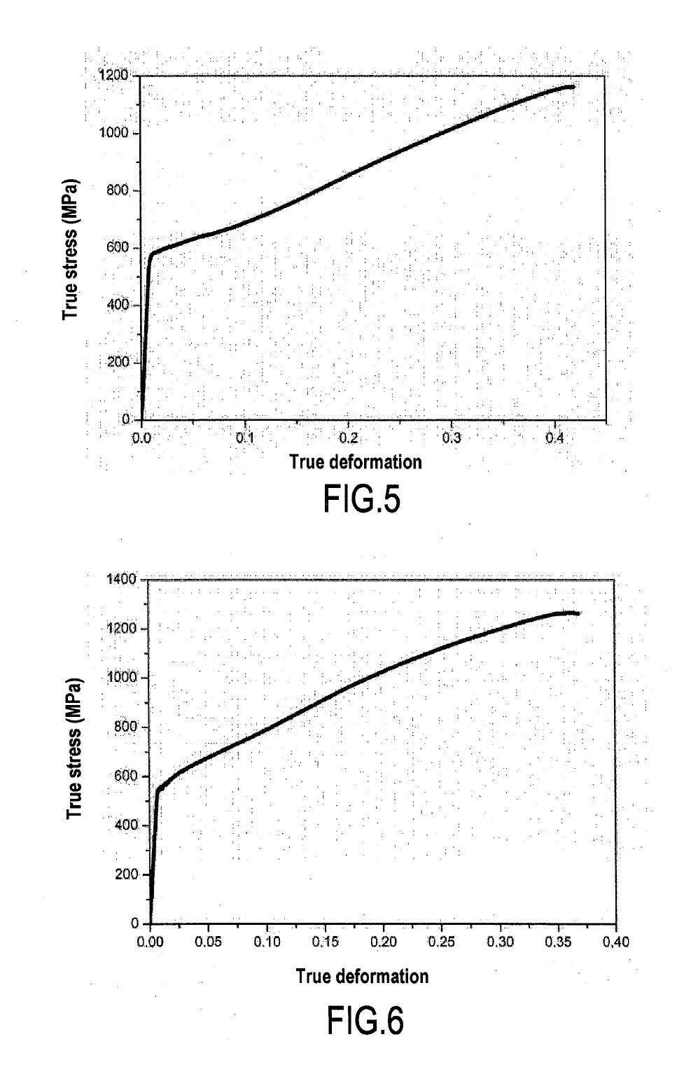

FIG. 5 shows the results of traction tests obtained for a Ti-8.5Cr-1.5Al alloy. For this alloy, e/a=4.129 and Mo_{eq}=12.1. This alloy presents high ductility of the order of 40%, a breaking load of 1150 MPa, and conserves a high elastic limit. Similar results are obtained for the Ti-8.5Cr-1.5Sn alloy for which Mo_{eq}=13.6 and e/a=4.16 (see FIG. 6). The traction tests were performed at ambient temperature with deformation at a rate of 10⁻³ s⁻¹ on test pieces having a length of 50 millimeters (mm), a thickness of 0.5 mm, and a width of 5 mm.

### Example

An ingot of Ti-8.5Cr-1.5Al alloy was fabricated by compacting titanium sponge elements, chromium grains, and aluminum powder, and then using the arc melting technique. In the compacted mixture, the following contents by weight were used: Ti 90% by weight, Cr 8.5% by weight, and Al 1.5% by weight. The ingot was then deformed in order to obtain a sheet having a thickness of 0.5 mm. The sheet was heat-treated at 900° C. in the beta domain followed by rapid cooling. Flat traction test pieces were cut out from the sheet and they were used in the context of the traction testing described above with reference to FIG. 5.

The term “including/containing a” should be understood as “including/containing at least one”.

The term “lying in the range . . . to . . . ” should be understood as including the bounds.

1. A turbine engine part including a titanium-based alloy in which one or more alloying elements are present, the alloy including at least one alloying element selected from the following list: Cr, Al, Sn, and V, and the alloy satisfying the following conditions:
$$4.10 \leq \frac{e}{a} \leq 4.16 ;$$
$$10 \leq {Mo}_{eq} \leq 14.5 ;$$
$$2.77 \leq Bo \leq 2.80 ; and$$
$$2.34 eV \leq Md \leq 2.38 eV ;$$
where Mo_{eq} designates the content by weight of beta-stabilizing elements in the alloy expressed as molybdenum equivalent,
where
$$\frac{e}{a} = \sum \frac{{e}_{i}}{{a}_{i}} {x}_{i} , where \frac{{e}_{i}}{{a}_{i}}$$
is the number of valence electrons of the element i and xᵢ is the molar fraction of the element i in the alloy, the sum being performed over all of the elements present in the alloy; where Bo designates the mean bond order of covalent bonds between the titanium and the alloying elements; and where Md designates the mean energy level in eV of the d orbitals corresponding to the covalent bonds between the titanium and the alloying elements.

2. A part according to claim 1, wherein the alloy includes Cr and Al as alloying elements.

3. A part according to claim 1, wherein the alloy includes Cr and Sn as alloying elements.

4. A part according to claim 2, wherein the alloy constitutes a Ti—Cr—Al ternary alloy.

5. A part according to claim 3, wherein the alloy constitutes a Ti—Cr—Sn ternary alloy.

6. A part according to claim 2, wherein the content by weight of Cr in the alloy lies in the range 6% to 9%, and the content by weight of Al in the alloy lies in the range 1% to 3%.

7. A part according to claim 3, wherein the content by weight of Cr in the alloy lies in the range 6% to 9%, and the content by weight of Sn in the alloy lies in the range 1% to 5%.

8. A turbine engine part including a titanium-based alloy, the alloy being:
a Ti—Cr—Al ternary alloy in which the content by weight of Cr in the alloy lies in the range 6% to 9% and the content by weight of Al in the alloy lies in the range 1% to 3%; or
a Ti—Cr—Sn ternary alloy in which the content by weight of Cr in the alloy lies in the range 6% to 9% and the content by weight of Sn in the alloy lies in the range 1% to 5%.

9. A part according to claim 1, wherein the content by weight of Cr in the alloy lies in the range 7% to 9%.

10. A part according to claim 1, wherein the part constitutes a turbine engine casing.

11. A part according to claim 10, wherein the part constitutes a turbine engine retention casing.

12. A turbine engine including a part according to claim 1.

13. A part according to claim 8, wherein the content by weight of Cr in the alloy lies in the range 7% to 9%.

14. A part according to claim 8, wherein the part constitutes a turbine engine casing.

15. A part according to claim 14, wherein the part constitutes a turbine engine retention casing.

16. A turbine engine including a part according to claim 8.
